(19) United States
(12) Patent Application Publication
(10) Pub. No.: US 2025/0068692 A1
(43) Pub. Date: Feb. 27, 2025

(54) REDUCING OPTIMIZATION TIME OF SIMULATION MODELS

(71) Applicant: Aveva Software, LLC, Lake Forest, CA (US)

(72) Inventors: Harry Scott Brown, Yorba Linda, CA (US); Ian H. Boys, Vista, CA (US); Nikhil Rajeev, Houston, TX (US)

(21) Appl. No.: 18/812,820

(22) Filed: Aug. 22, 2024

Related U.S. Application Data
(60) Provisional application No. 63/534,193, filed on Aug. 23, 2023.

(51) Int. Cl. G06F 17/11

(52) U.S. Cl. CPC G06F 17/11

(57) ABSTRACT

A system identifies an ordered data structure that enables a computer to follow a particular order of execution for solving blocks of equations that collectively constitute a simulation model. The system uses the ordered data structure to identify a subset of the blocks of equations that require optimizing by an optimizer program and/or a remaining set of blocks of equations which can be solved without optimization by the optimizer program. The optimizer program optimizes only the subset of the blocks of equations that require optimizing by the optimizer program, thereby reducing an amount of computer resources required for optimization, by varying any blocks of equations declared as independent variables in an iterative process until the optimizer program generates optimized values that converge on a solution. Using the optimized values, a solver program executes each calculation only once when sequentially solving the remaining set of the blocks of equations.

### CROSS REFERENCE TO RELATED APPLICATION

This application claims priority to U.S. Provisional Patent Application No. 63/534,193 filed Aug. 23, 2023, which is hereby incorporated herein by reference.

### BACKGROUND

An organization that uses sensors to monitor an industrial facility may find it impractical to install hardware and software to measure every parameter in an industrial process. A common solution for such an organization is to build a simulation model of an industrial system or process using various mathematical equations. Consequently, various parameters of the industrial facility not directly monitored by sensors can be determined mathematically and displayed by the simulation model as though actual sensors were physically present.

A model consists of the equations used to imitate the behavior of a system or a process. By contrast, a computer simulation is the actual running of the solver program(s) that execute algorithms which solve those equations, often in an approximate manner. Industrial process simulators can divide an industrial process simulation model into blocks of equations which define the behavior of particular industrial assets, such as a pump, a reactor, a pipe, or combination thereof.

One or more solver programs sequentially solve these blocks of equations. In most cases, the simulation model has downstream blocks of equations that require solutions from upstream blocks of equations in order to converge on an overall solution. Therefore, an ordered data structure which may be referred to as an order table, an order graph, a directed graph, or a solver dependencies graph, is created which provides the solver programs with a particular order of execution for solving multiple blocks of equations. FIG. 1 illustrates a simplified example of order table 102 that represents a simulation model's solver dependencies in a directed graph used by a system 100 for reducing optimization time of simulation models, according to some embodiments.

There is some flexibility in the order depicted in FIG. 1 for executing the blocks of equations. For example, based on the order table 102, the block execution orderings of <A, B, C, D, E, F> and <B, D, F, A, C, E> are valid. In contrast, <B, C, A, D, E, F> is not a valid block execution ordering because solving block <C> requires block <A> and block <B> to have been already solved, and block <A> runs after block <C> in this invalid example.

Simulation-based optimization integrates optimization techniques into simulation modeling and analysis. Once a system or a process is mathematically modeled, computer-based simulations provide information about its behavior. Parametric simulation methods can be used to improve the performance of a simulated system or process. In this method, the input of each variable is varied with other parameters remaining constant and the effect on the design objective is observed.

This is a time-consuming method and improves the performance partially. To obtain the optimal solution with minimum computation and time, the problem is solved iteratively where in each iteration the solution moves closer to the optimum solution. Such methods are known as “numerical optimization” or “simulation-based optimization.”

In a simulation experiment, the goal is to evaluate the effect of different values of input variables on a system. However, the interest is sometimes in finding the optimal value for input variables in terms of the system outcomes. One way could be running simulation experiments for all possible input variables.

However, this approach is not always practical due to several possible situations and running experiments for each scenario may be impractical. For example, there might be too many possible values for input variables, or the simulation model might be too complicated and expensive to run for a large set of input variable values. In these cases, the goal is to iteratively find optimal values for the input variables rather than trying all possible values.

When trying to optimize a simulation model, a system administrator may designate one or more blocks of equations as independent variables when sending the simulation model to an optimizer program. The optimizer program can execute an interactive process varying the independent variables in an iterative process until the optimizer program converges on a solution for the entire simulation model, which should yield a more desirable result, such as a higher profit or a lower reactor temperature. However, analyzing the simulation model using the optimizer program is time consuming and requires significantly greater computer resources than a solver program uses when solving each equation only once while determining the values for all blocks of equations.

### BRIEF DESCRIPTION OF THE DRAWINGS

FIG. 1 illustrates an example order table that represents a simulation model's solver dependencies in a directed graph used by a system for reducing optimization time of simulation models, according to some embodiments.

FIG. 2 illustrates a block diagram of an example algorithm that includes or excludes blocks for being optimized, as implemented by a system for reducing optimization time of simulation models, according to some embodiments.

FIG. 3 illustrates an example of a traditional feasible path optimization.

FIG. 4 illustrates the differences between a traditional feasible path optimization and an example algorithm that includes or excludes blocks for being optimized, as implemented by a system for reducing optimization time of simulation models, according to some embodiments.

FIG. 5 illustrates an example directed graph for a simple chemical process simulation by a system for reducing optimization time of simulation models, according to some embodiments.

FIG. 6 illustrates an example directed graph where the objective function variable is calculated by a system for reducing optimization time of simulation models, according to some embodiments.

FIG. 7 illustrates an example solver dependencies graph with each block's equations indicated by a system for reducing optimization time of simulation models, according to some embodiments.

FIG. 8 illustrates an example of improvement when implementing various aspects of a system for reducing optimization time of simulation models, according to some embodiments.

FIG. 9 illustrates an example solver report generated by a system for reducing optimization time of simulation models, according to some embodiments.

FIG. 10 illustrates another example improvement provided by a system for reducing optimization time of simulation models, according to some embodiments.

FIG. 11 illustrates an example of an ability to avoid unnecessary troubleshooting during optimization by a system for reducing optimization time of simulation models, according to some embodiments.

FIG. 12 illustrates an example of identifying a missing block link by a system for reducing optimization time of simulation models, according to some embodiments.

FIG. 13 illustrates an example of a cumene reactor process simulation model as an example simulation by a system for reducing optimization time of simulation models, according to some embodiments.

FIG. 14 illustrates an example improvement in time for optimization provided by a system for reducing optimization time of simulation models, according to some embodiments.

FIG. 15 illustrates a block diagram of an example system for reducing optimization time of simulation models, according to some embodiments.

FIG. 16 is a flowchart that illustrates an example computer-implemented method for reducing optimization time of simulation models, according to some embodiments.

FIG. 17 is a block diagram illustrating an example hardware device in which the subject matter may be implemented.

### DETAILED DESCRIPTION

This disclosure is directed to systems and methods (collectively referred to as the “system” herein) that implement a computer program that may be referred to as a moderator program, which significantly reduces the amount of computer resources needed to optimize a simulation model. The moderator program can moderate the costly use of an optimizer program for optimizing some blocks of equations that constitute a simulation model and the inexpensive use of solver programs for solving the remaining blocks of equations in the simulation model. The moderator program can identify which blocks of equations should be optimized through the optimizer program, which implicitly identifies the remaining blocks of equations as parts of the simulation model that could be solved without processing through the optimizer program. Therefore, prior to and/or during a transfer of a simulation model to an optimizer program, the moderator program can exclude the blocks of equation that could be solved without optimizing by the optimizer program from the blocks of equations that constitute the simulation model, thereby leaving only a remaining reduced-size set of blocks of equations for optimization by the optimizer program. Consequently, the moderator program divides the optimization calculation into two parts, the first part of the optimization calculation that uses the optimizer program to optimize one or more non-excluded blocks of equations and thereby generate optimized values that a second part of the optimization calculation uses a solver program to solve the blocks of equations which were excluded from the optimizing process.

The moderator program can identify all blocks of equations that represent an objective function or an independent variable, or connect a block representing an objective function with any block representing an independent variable as blocks that should be optimized by the optimizer program. The moderator program can also identify all blocks of equations that include variable bounds which prevent convergence on erroneous results, or connect blocks that include variable bounds with blocks which represent an objective function or an independent variable, as blocks that should be optimized by the optimizer program.

In embodiments, a system identifies an ordered data structure that enables a computer to follow a particular order of execution for solving blocks of equations that collectively constitute a simulation model. The system uses the ordered data structure to identify a subset of the blocks of equations that require optimizing by an optimizer program and/or a remaining set of blocks of equations which can be solved without optimization by the optimizer program. The optimizer program optimizes only the subset of the blocks of equations that require optimizing by the optimizer program, thereby reducing an amount of computer resources required for optimization, by varying any blocks of equations declared as independent variables in an iterative process until the optimizer program generates optimized values that converge on a solution. Using the optimized values, a solver program executes each calculation only once when sequentially solving the remaining set of the blocks of equations.

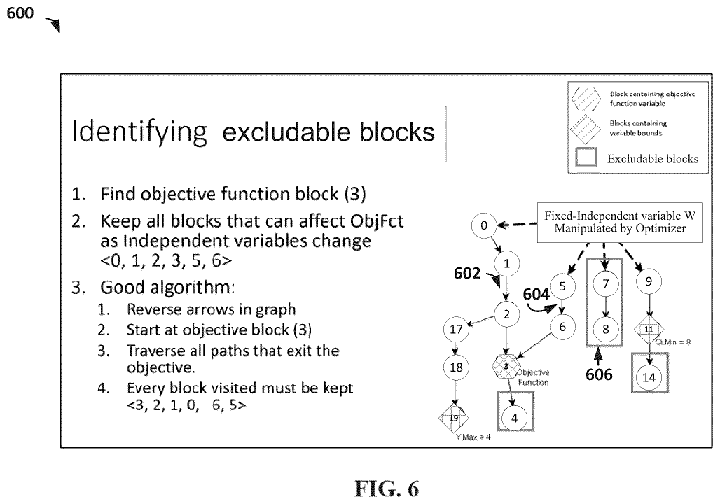

For example, a moderator program uses the order table that is partially depicted by FIG. 6 for a simulation model's 20 blocks of equations, and identifies blocks <1-3, 5, 6, 9, 11, 17-19> as requiring optimization because block <3> represents the objective function, blocks <0, 5, 7, 9> represent independent variables, blocks <0, 1, 2, 5, 6> connect the objective function block <3> to independent variable blocks, blocks <11, 19> contain variable bounds, and blocks <0, 1, 2, 9, 17, 18> connect variable bound blocks <11, 19> to independent variable blocks. Instead of spending computer resources on optimizing all 20 blocks of equations, the optimizer program conserves computer resources by optimizing only the 11 blocks of equations identified by the moderator program as requiring optimization to generate optimized values. Then a solver program uses the optimized values, which converge on a solution that increases profits, and conserves computer resources by solving only the remaining 9 blocks of equations, which are blocks <4, 7, 8, 10, 12-16>.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. Operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

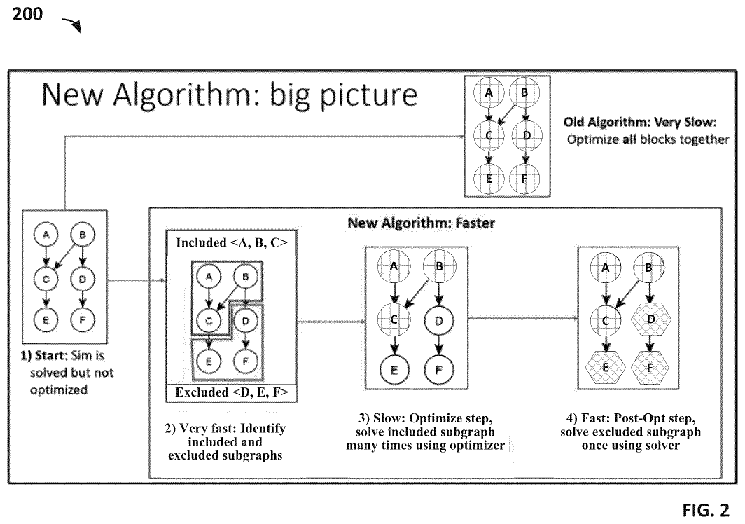

FIG. 2 illustrates a block diagram of an example algorithm that includes or excludes blocks for optimizing, as implemented by a system for reducing optimization time of simulation models, according to some embodiments. In step 1), a solver program solves a simulation model's blocks of equations, which are not optimized. The old algorithm could optimize the simulation model's block of equations, but the optimization would be very slow because all of the blocks <A, B, C, D, E, F> would be optimized together.

As an alternative to the quickly solved but unoptimized blocks depicted in step 1) and an alternative to the old algorithm's slowly optimized blocks, step 2) depicts that the moderator program quickly executes the new algorithm to identify blocks <A, B, C> as the only blocks that should be included for optimizing and therefore identifies blocks <D, E, F> as blocks that could be excluded from being optimized. Then step 3) depicts using the optimizer program to solve the included blocks <A, B, C> many times, which is executed much faster than the old algorithm solving all 6 blocks <A, B, C, D, E, F> many times for each independent variable change iteration. However, due to the optimizer program's iterative variation of independent variables, the optimization is slower than the solver program solving all 6 blocks <A, B, C, D, E, F> only one time in step 1) and slower than using the solver program to solve the blocks <D, E, F>, which are excluded from optimizing, only one time in step 4) By deferring as many of the blocks of equations' calculations as possible to the faster post-optimization solving that only uses the solver program to solve each equation only once, the overall computation time for optimization is decreased, as is also demonstrated in later examples.

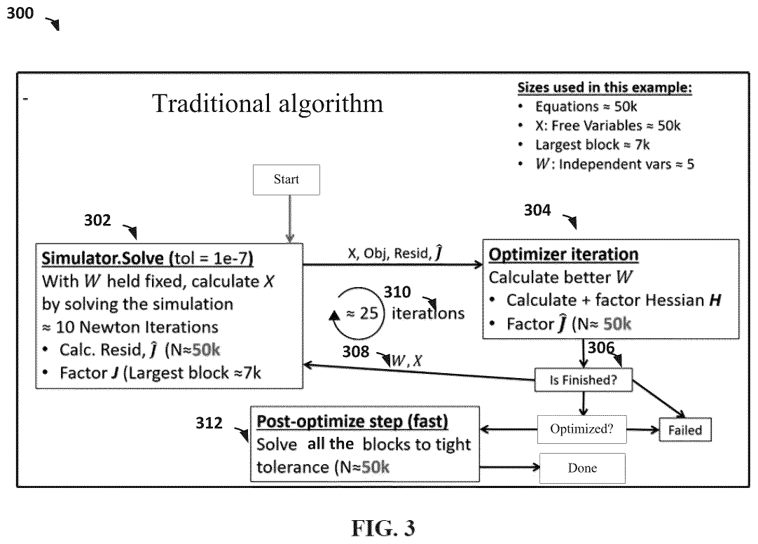

FIG. 3 illustrates an example of a traditional feasible path optimization. A feasible-path optimization includes techniques for solving large, constrained optimization problems. It differs from infeasible-path optimization in that it solves the entire simulation model to completion at every optimization step, which improves solver robustness at the cost of increased runtime.

The traditional feasible path optimization starts by running a solver simulation, such as Simulator.Solve( ) 302, with the independent variables, W, held fixed, to solve the entire square simulation using a nonlinear solver like Newton's method. The system can calculate free variables X, Jacobian J, Residuals and/or the objective function. At the end of this step in the example, the system has solved, but not optimized, 50,000 equations.

Then an optimizer iteration 304 executes with the results calculated by the Simulator.Solve( ) which produces results that are “more optimal” values for the (5) independent variables. To update the independent variables, the optimizer program will need to factor the large (N=50,000) Jacobian matrix. The most time-consuming task for a Sequential Quadratic Programming (SQP) optimizer is the loading and factoring of large Jacobian and Hessian matrices. The Hessian matrix is also large, but is factored faster than the Jacobian matrix.

If an optimized solution is not finished 306 being produced yet, the updated independent variables, W, are sent 308 back to the Simulator. Solve( ) to repeat the cycle. As many as 25 iterations 310 is not unusual. When an optimized solution is eventually finished being produced, the Simulator.Solve( ) runs one more time post-optimization, which is fast because the simulation has already been solved, to make sure that the tight tolerances 312 are met. However, a simulation model can have thousands of trivial blocks that do not affect the optimization. These blocks are usually small, linear, and easily solved.

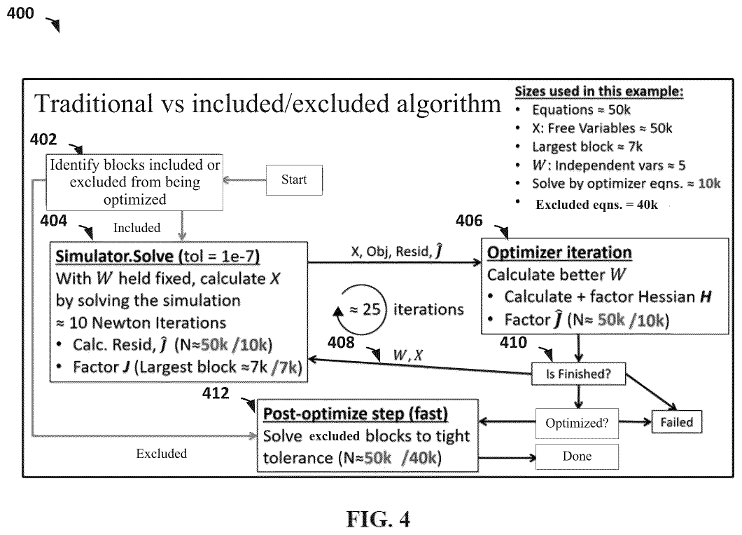

FIG. 4 illustrates the differences between an example of a traditional feasible path optimization and an example algorithm that includes or excludes blocks for being optimized, as implemented by a system for reducing optimization time of simulation models, according to some embodiments. The moderator program starts by executing the new algorithm to identify the blocks that are included or excluded from being optimized 402, which are the blocks of equations that should be optimized and the blocks of equations which may be processed without being optimized, which is a fast calculation that only needs to be run once. Then the optimizer program can use Simulator.Solve 404 to solve a simulation model that retains only the included blocks, which include only blocks sequentially preceding blocks representing the independent variable W and/or an objective function. This resulting simulation model may be much smaller than the initial simulation model, such as 10,000 included equations compared to 50,000 equations representing the entire simulation model, which is an 80% reduction. As in the traditional execution, the few independent variables, W, are held fixed.

Then an optimizer iteration 406 executes with the results calculated by the Simulator.Solve( ) which produces results that are “more optimal” values for the (5) independent variables. To update the independent variables, the optimizer program will need to factor the reduced-size (N=10,000) Jacobian matrix, but the Jacobian and Hessian matrices are now much faster to factor because the reduced size model has only 10,000 equations.

The loop 408 between Simulator.Solve( ) and the optimizer iteration is repeated. If the optimized solution is finished 410 being solved, the post-optimize step 412 runs fast, such as calculating solutions for the (40,000) excluded equations, which have not yet updated from the optimized equations, which may be solved quickly because most of the excluded equations are less computationally intensive to solve.

The runtime improvement comes from the much smaller models in both the solver and optimizer steps. Factoring a matrix with a size of 10,000 equations is much faster than factoring a matrix with the size of 50,000 equations, even if a sparse linear algebra package divides the simulation model into sub blocks. The Newton iterations in the solver program are faster due to the many blocks of equations being excluded from optimization. Since many of these blocks of equations have only a single equation to solve, the equations do not require a high-cost calculation. The traditional feasible-path optimization performs many block calculations that are not actually needed by the optimizer program, such as chemical process simulators calculating fluid properties that have no influence on the optimization calculations.

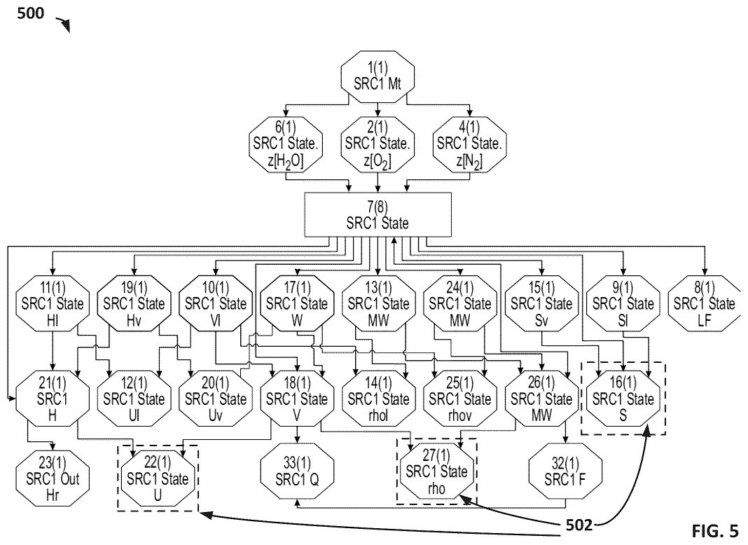

FIG. 5 illustrates an example directed graph 500 for a simple chemical process simulation by a system for reducing optimization time of simulation models, according to some embodiments. Terminal blocks <27, 22, 16> calculate the density, internal energy, and entropy fluid properties. Since these blocks of equations 502 have no out-bound edges-they cannot affect the objective function block or any other. The moderator program improves runtime by excluding these blocks without out-bound edges from the costly optimization phase. The moderator program can determine which blocks of equations do not influence the objective function, exclude these blocks from the optimization calculation, and then use the solver program to solve the excluded blocks in a post optimization step which is faster than the optimization step.

The moderator program can execute an objective function determination and a variable bounds determination, which may be based on two aspects to constrained optimization problems. One aspect is to maximize and/or minimize an objective function, such as an objective function for profit, while the other aspect is determining all of the blocks of equations that affect the objective function. FIG. 6 illustrates an example directed graph where the objective function variable is calculated by a system for reducing optimization time of simulation models, according to some embodiments. The moderator program can identify one or more blocks of equations that are connected to one or more blocks of equations which represent the independent variables W. The graph shows that the branch 602 of blocks <0, 1, 2> and the branch 604 of blocks <5, 6> both affect block <3>, which represents the objective function, and therefore must be included for being optimized. Blocks <7, 8> 606, in contrast, have no path to the objective function's block of equations, and therefore can be excluded from being optimized.

The moderator program can identify a block of equations that represent an objective function, reverse the arrows in the order table, then traverse the reversed graph starting from the block for the objective function, and ending at any of the independent variables, keep (instead of exclude) every block visited, and send the kept blocks to the optimizer program. The moderator program can identify variable bounds, and send the identified variable bounds to the optimizer program, which needs to know about variable bounds so that it can manipulate the independent variables, W, without violating any bounds on other variables.

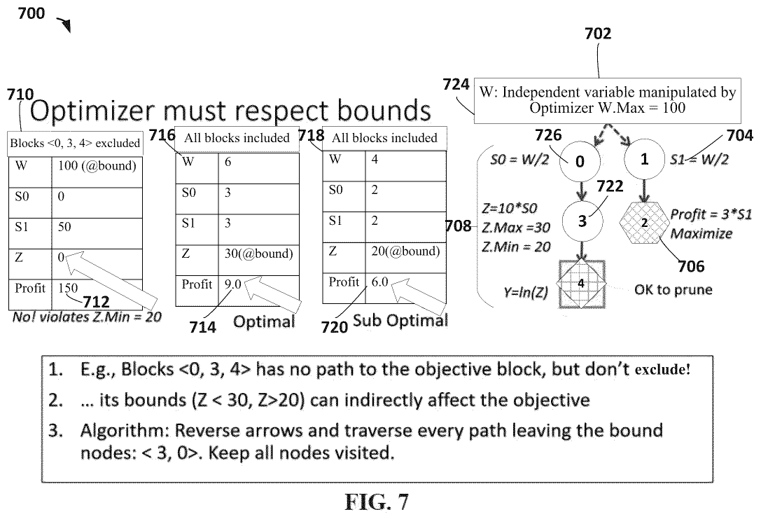

FIG. 7 illustrates an example solver dependencies graph 702 with each block's equations 704 indicated by a system 700 for reducing optimization time of simulation models, according to some embodiments. Since blocks <0, 3, 4> do not directly affect the profit block <2> 706 which represents the objective function, it might appear as though blocks <0, 3, 4> 708 can be excluded from being optimized. However, this is not correct because the variable bounds in a block can indirectly affect the solution.

The results from excluding blocks <0, 3, 4> 708 are shown in Table 710 of FIG. 7. The optimizer program returned a profit function of 712 when blocks with variable bounds were excluded from being optimized. A simulation modeling system can execute a verification check, which executes an optimization using all blocks, without excluding any blocks from the simulation model, and then compares the all-blocks result to the partial blocks result. For the partial blocks results to be correct, they must match the results from the optimization run with all blocks.

Optimizing at the upper bound with all blocks shows the correct maximized profit is [9] 714 in table 716. Table 718 shows a correct minimized profit is [6.0] 720 when all lower bounds are included. The simulation modeling system can identify all blocks that calculate a variable with a bound, which is only block <3> 722 in this example. The simulation modeling system can transpose the graph 702, then traverse the transposed graph 702 starting from each bound block. For example. starting from block <3> 722, the only block in a path to a block 724 that represents an independent variable is block <0> 726, which would be included with block <3> 722 for being optimized.

Each block visited from a block which includes a variable bound to a block that represents an independent variable should be included for being optimized. Each of the included blocks and the variable bounds should be sent to the optimizer program. The simulation modeling system can prevent the removal of blocks of a simulation model that have variable bounds, which are executed to prevent convergence on erroneous results.

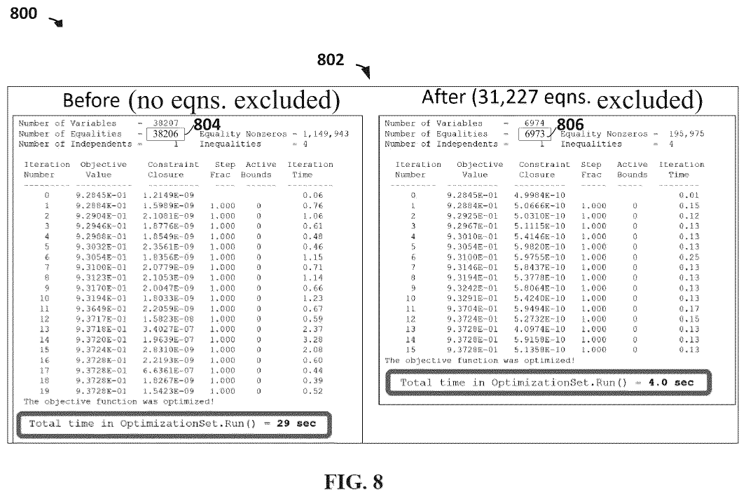

The number of blocks excluded for being optimized may be a significantly large number of blocks, with most of these blocks containing a single equation and variable. FIG. 8 illustrates an example of improvement 802 when implementing various aspects of a system 800 for reducing optimization time of simulation models, according to some embodiments. In this example, the improvement 802 is a reduced model size from [38,206] total equations 804 to [6,973] included equations 806.

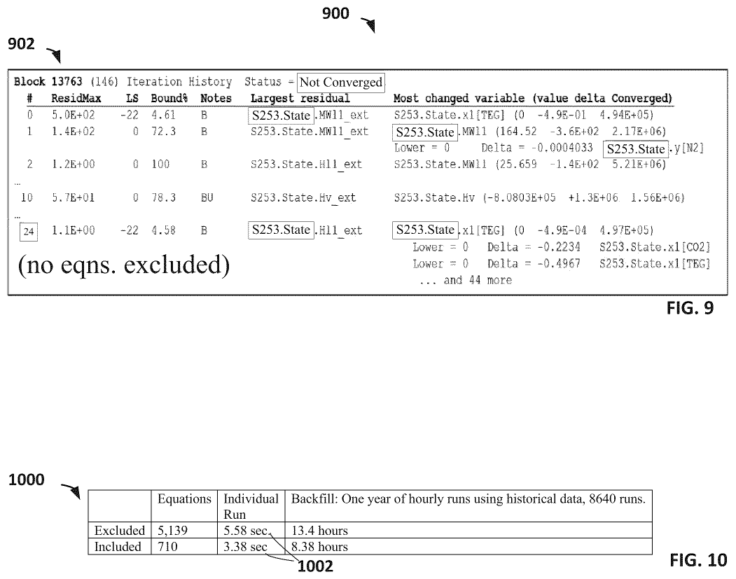

The speed increases include the optimizer program avoiding some intermediate solver failures during the optimization phase. The optimizer program can generate a solver report. FIG. 9 illustrates an example solver report 902 generated by a system 900 for reducing optimization time of simulation models, according to some embodiments. The solver report 902 shows that block <13763> failed to converge, which caused the optimizer program to exclude the block <13763> and try again. If the same run is attempted with the block excluding option on, no warnings from block <13763> are generated, because the optimizer program correctly determined that block <13763> was not needed for optimization calculations. Block <13763> was eventually solved, without incident, post-optimization by the solver program.

FIG. 10 illustrates another example improvement 1002 provided by a system 1000 for reducing optimization time of simulation models, according to some embodiments. The example report shows one year of hourly data reconciliation runs for compressor performance monitoring. The runtime improvement 1002 depicted may be due to the smaller matrices used throughout the calculations.

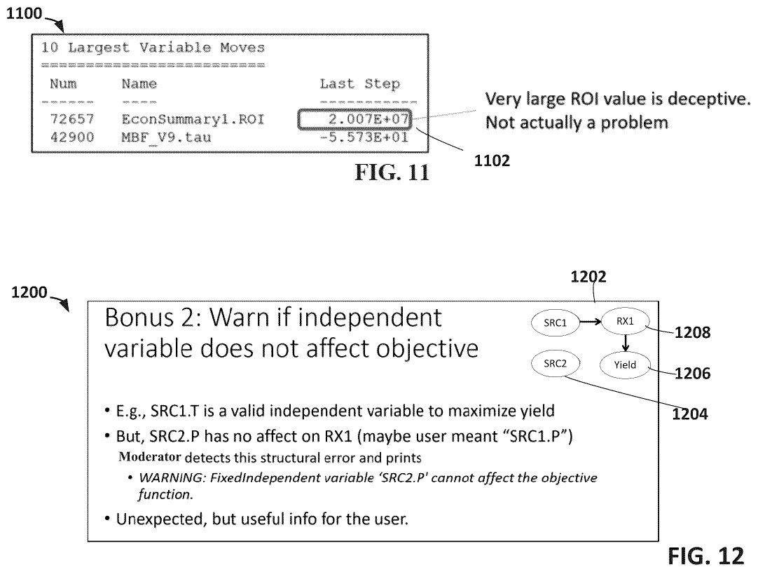

FIG. 11 illustrates an example of an ability to avoid unnecessary troubleshooting during optimization by a system 1100 for reducing optimization time of simulation models, according to some embodiments. Sometimes an all-blocks run can report warnings about a variable that would be absent in a reduced size block run, which can lead to wasted troubleshooting effort. For example, the FIG. 11 example optimization outputs a warning 1102 that the return on investment (ROI) value was changing very rapidly. However, when the optimization is run with the excluding blocks option on, the return on investment warning is absent, and its block is excluded from optimization.

If the moderator program detects declared independent variables that do not influence an objective function, the moderator program can issue a warning to a user for variables that should not be declared as independent. As a result of the reduced size of any optimization problem, the moderator program can more easily identify and then warn a user if a user-declared independent variable has no effect on the optimization calculation. The moderator program can report more diagnostic information, which helps engineers trying to troubleshoot failing optimization runs by removing variables that are determined to not affect the optimization, thereby resulting in smaller problems that are easier to troubleshoot.

The moderator program can check an order graph for missing block links. FIG. 12 illustrates an example of identifying a missing block link by a system 1200 for reducing optimization time of simulation models, according to some embodiments. When a user declares a variable as independent, the user is expecting that that variable has an effect on the objective function and should be warned if this is not the case. The moderator program can detect and/or report any block that represents an independent variable that does not have a path to the block that represents the objective function. For example, the order graph 1202 in FIG. 12 shows that there is no path from the block 1204 for SRC2 to the block 1206 for the objective function, Yield. It would be unusual for a user to declare SRC2.P as an independent variable, so the moderator program generates a warning. The user may have intended to make SRC1.P independent, or maybe forgot to connect the block 1204 for SRC2 to the block 1208 for RX1 in the order graph 1202.

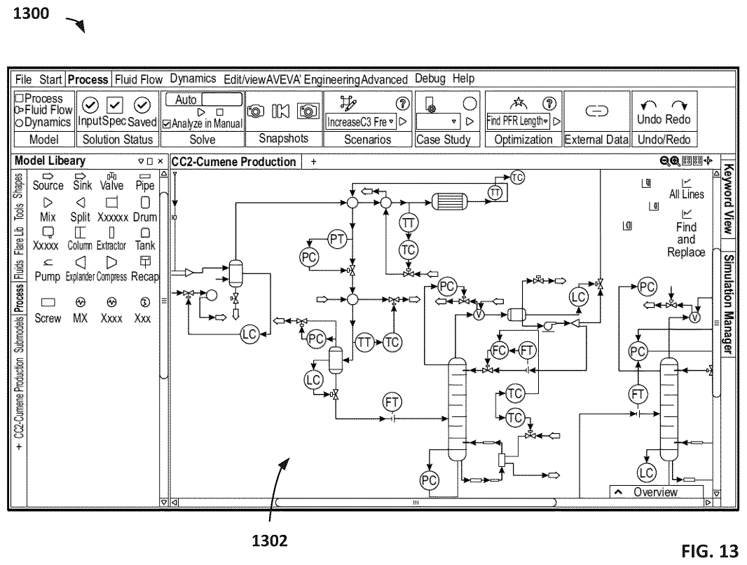

FIG. 13 illustrates an example of a cumene reactor process simulation model 1302 as an example simulation by a system 1300 for reducing optimization time of simulation models, according to some embodiments. The simulation model 1302 depicts models for the cumene reactor's system components such as compressors, drums, expanders, extractors, mixers, pipes, pumps, sinks, sources, splits, tanks, and valves.

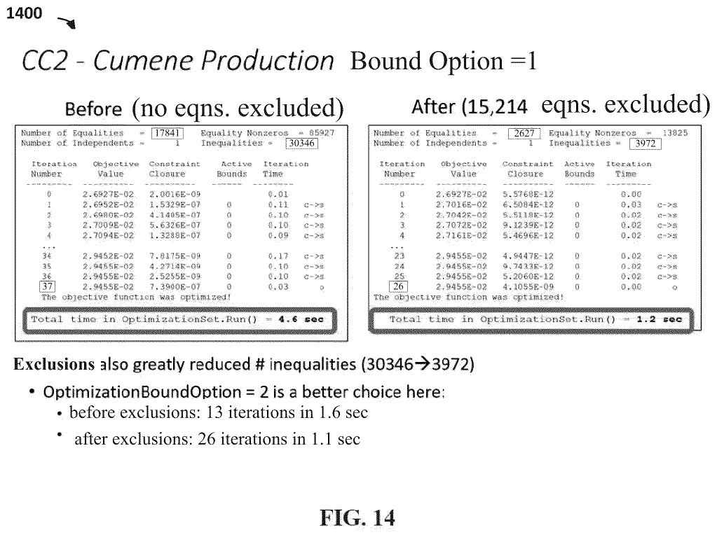

FIG. 14 illustrates an example improvement in time for optimization provided by a system 1400 for reducing optimization time of simulation models, according to some embodiments. The improvements created by the simulating model system include a reduction in total time in optimization from 4.4 seconds for all 17,841 equations to 1.2 seconds for the reduced model size of only the 2,627 equalities that should be optimized.

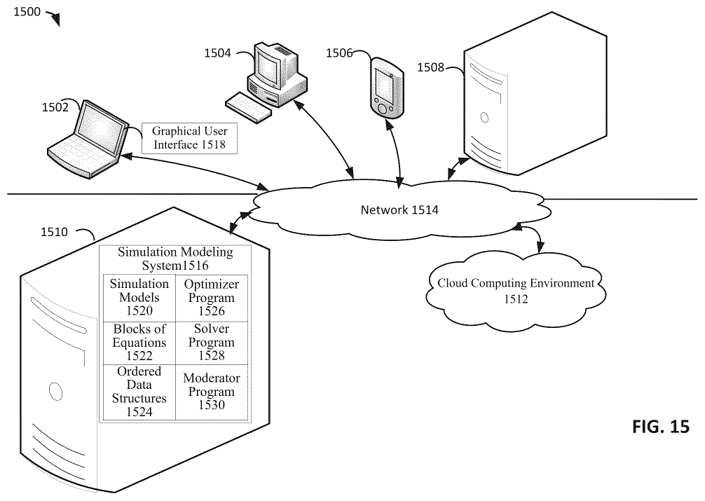

FIG. 15 illustrates a block diagram of an example system 1500 for reducing optimization time of simulation models, under an embodiment. As shown in FIG. 15, the system 1500 may illustrate a cloud computing environment in which data, applications, services, and other resources are stored and delivered through shared data centers and appear as a single point of access for the users. The system 1500 may also represent any other type of distributed computer network environment in which servers control the storage and distribution of resources and services for different client users.

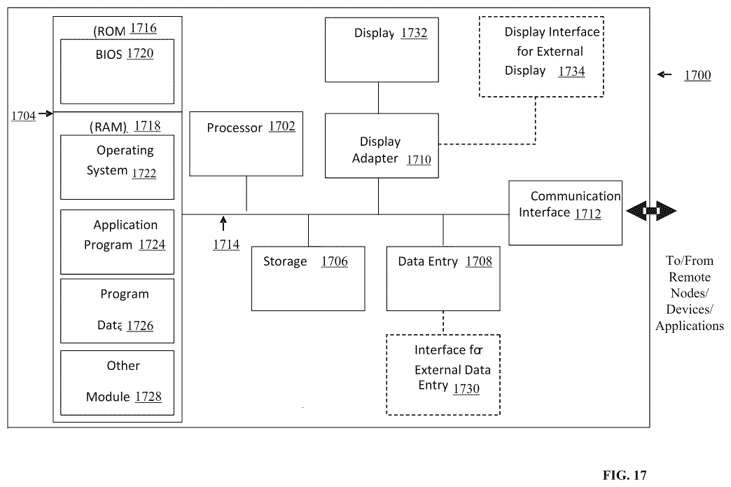

In an embodiment, the system 1500 represents a cloud computing system that includes a first client 1502, a second client 1504, a third client 1506, a fourth client 1508, and a server 1510 and an optional cloud computing environment 1512 that may be provided by a hosting company. The clients 1502-1508, the server 1510, and the cloud computing environment 1512 communicate via a network 1514. Even though FIG. 15 depicts the first client 1502 as a laptop computer 1502, the second client 1504 as a desktop computer 1504, the third client 1506 as a smart phone 1506, and the fourth client 1508 as a server, each of the system components 1502-1510 may be any type of computer system, and may each be substantially similar to the hardware device 1700 depicted in FIG. 17 and described below.

The server 1510 can host and execute a simulation modeling system 1516, which may be accessed via a graphical user interface 1518, as depicted by FIG. 15, and/or reside on any of the clients 1502-1508. The simulation modeling system 1516 includes simulation models 1520, blocks of equations 1522, ordered data structures 1524, optimizer programs 1526, solver programs 1528, and moderator programs 1530.

Although FIG. 15 depicts the simulation modeling system 1516 and all of the system components 1520-1530 residing completely on the server 1510, any or all of the system and its components 1516-1530 may reside completely on the clients 1502-1508, completely on the cloud computing environment 1512, or in any combination of partially on the clients 1502-1508, partially the server 1510, partially on the cloud computing environment 1512 and/or partially on another server which is not depicted in FIG. 15. FIG. 15 depicts the system 1500 with four clients 1502-1508, one server 1510, one cloud computing environment 1512, one network 1514, one simulation modeling system 1516, and one graphical user interface 1518. However, the system 1500 may include any number of clients 1502-1508, any number of server 1510, any number of cloud computing environment 1512, any number of network 1514, any number of the simulation modeling system 1516, and any number of graphical user interface 1518.

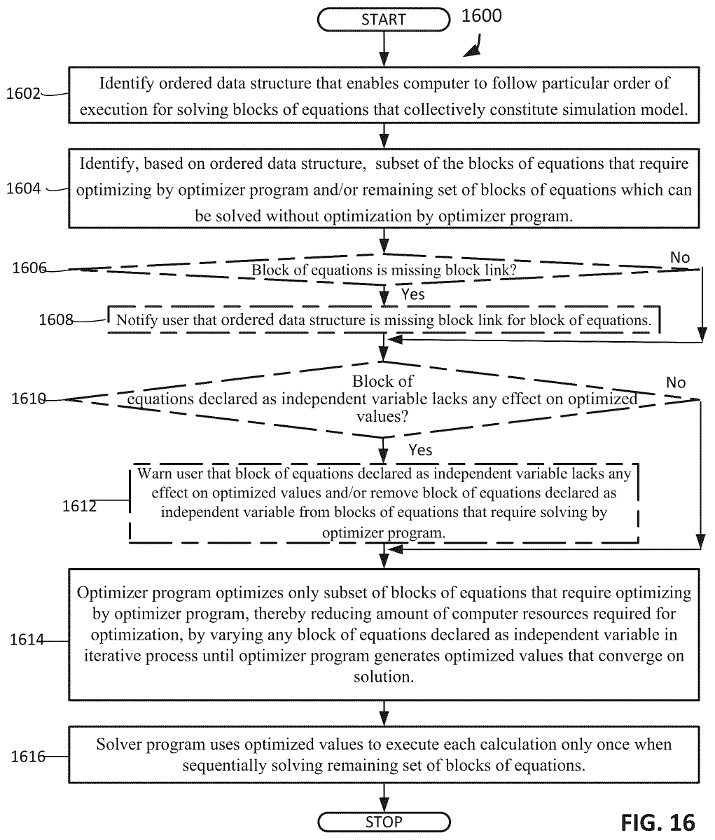

FIG. 16 is a flowchart that illustrates a computer-implemented method for reducing optimization time of simulation models, under some embodiments. Flowchart 1600 depicts method acts illustrated as flowchart blocks for certain actions involved in and/or between the system elements 1502-1530 of FIG. 15.

An ordered data structure is identified that enables a computer to follow a particular order of execution for solving blocks of equations that collectively constitute a simulation model, block 1602. The system identifies an order table for reducing optimization time. For example, and without limitation, this can include the moderator program 1530 identifying the ordered data structure 1524 that is partially depicted by FIG. 6 for 20 blocks of equations 1522 from one of the simulation models 1520.

An ordered data structure can be a collection of information items where each information item holds a relative position that is based upon some underlying characteristic of the information item. A computer can be an electronic device for storing and processing data, typically in binary form, according to instructions given to it in a variable program. A particular order can be a series of items, events, or elements has been arranged in a specific manner.

Execution can be the performance of an instruction or program. A block can be a large piece of text processed as a unit. An equation can be a statement that the values of two mathematical expressions are equal. A simulation model can be a series of equations that a computer uses to imitate the behavior of a system or a process.

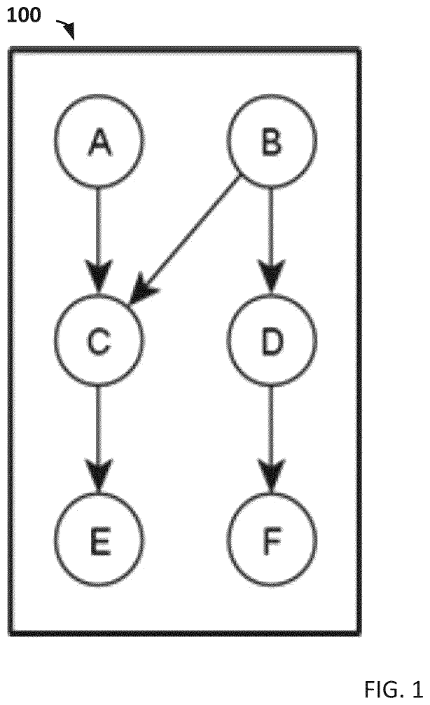

The ordered data structure may be an order table, an order graph, a directed graph, and/or a solver dependencies graph, and the blocks of equations may be created by an industrial process simulator that divides the simulation model 1520 for an industrial process. For example, the ordered data structure 1524 depicted in FIG. 1, FIG. 2, FIG. 5, FIG. 6, and FIG. 7 may be referred to as an order table.

An order table can be a visual and/or mathematical rendering of a sequence of interdependent tasks. An order graph can be a data structure that defines a sequence of interdependent tasks. A directed graph can be a set of vertices connected by edges. A solver dependencies graph can be a data structure that describes the support of an entity in a system that is directed for the other entities of the same system.

An industrial process can be a series of steps that use chemical, physical, electrical, or mechanical actions to manufacture or produce something, usually on a large scale. An industrial process simulator can be software that describes flow diagrams, where unit operations are positioned and connected by product streams.

After identifying an ordered data structure, the ordered data structure is used to identify a subset of the blocks of equations that require optimizing by an optimizer program and/or a remaining set of blocks of equations which can be solved without optimization by the optimizer program, block 1604. The system identifies which blocks require optimization and which blocks do not require optimization. By way of example and without limitation, this can include the moderator program 1530 identifying blocks <1-3, 5, 6, 9, 11, 17-19> as requiring optimization because block <3> represents the objective function, blocks <0, 5, 7, 9> represent independent variables, blocks <0, 1, 2, 5, 6> connect the objective function block <3> to independent variable blocks, blocks <11, 19> contain variable bounds, and blocks <0, 1, 2, 9, 17, 18> connect variable bound blocks <11, 19> to independent variable blocks.

A subset can be a part of a larger group of related items. An optimizer program can be software that uses algorithms that adjusts parameters to improve or maximize the performance of a system or process. A remaining set can be a residual part of a larger group of related items. Optimization can be the adjustment of parameters to improve or maximize the performance of a system or process.

Identifying the subset of the blocks of equations that require optimizing by the optimizer program may include traversing the ordered data structure from a block of equations for an objective function to each of the blocks of equations declared as independent variables, and identifying each block of equations visited during the traversing as requiring optimizing by the optimizer program. For example, the moderator program traverses the graph partially depicted by FIG. 6 from block <3> which represents the objective function to the block which represents the independent variable W via the branch 602 of blocks <0, 1, 2> and the branch 604 of blocks <5, 6>, such that the blocks <0, 1, 2, 3, 5, 6> are therefore included for being optimized. An objective function can be at least one equation whose value is to be either minimized or maximized subject to the constraints to solve optimization problems. Solving can be the determining of an answer to at least one equation.

Identifying the subset of the blocks of equations that require optimizing by the optimizer program may include identifying a block of equations that have variable bounds, which are executed to prevent convergence on erroneous results, or traversing the ordered data structure from each block of equations that have variable bounds to each of the blocks of equations declared as independent variables, and identifying each block of equations visited during the traversing as requiring optimizing by the optimizer program. Then the moderator program 1530 sends each variable bound identified during the traversing to the optimizer program 1526 so that the optimizer program 1526 can manipulate a solution for blocks of equations declared as independent variables without violating any variable bound on any other solution for an blocks of equations declared as independent variables. For example, the moderator program 1530 identifies the blocks <11, 19> as depicted by FIG. 6. For another example, the moderator program 1530 traverses the ordered data structure 1524 from blocks <11, 19> which contain variable bounds, to the independent variable block via the blocks <0, 1, 2, 9, 17, 18> which connect variable bound blocks <11, 19> to independent variable block, identifies the blocks <0, 1, 2, 9, 11, 17-19> as blocks that should be included for being optimized, and sends the variable bounds from blocks <11, 19> to the optimizer program 1526. The optimizer program 1526 can use the identified blocks of equations to manipulate a solution for any blocks of equations declared as independent variables without violating any variable bound on any other solution for any blocks of equations declared as independent variables.

A variable bound can be mathematical constraints which ensure that a solution to an equation is well-formed. Convergence can be the integration of two or more entities in a single system. An erroneous result can be a solution that is wrong, inaccurate, or contains an error. Visited can be to come or go to.

Traversing can be traveling across or through a block of equations. To manipulate can be to control or influence. A solution can be the solving of an equation. Violating can be to break or fail to comply with a rule.

Following the identification of blocks that do or do not require optimization, whether a block of equations is missing a block link in the ordered data structure is optionally determined, block 1606. The system can check for missing block links. In embodiments, this can include the moderator program 1530 determining if a block of equations is missing a block link in the ordered data structure, as depicted by FIG. 12. A block link can be a directional connector between a set of data and another set of data.

If a block of equations is missing a block link in the ordered data structure, then the flowchart 1600 continues to block 1608 to notify a user. If no block of equations is missing a block link in the ordered data structure, then the flowchart 1600 proceeds ahead to block 1610 to optionally verify independent variables.

If a block of equations is missing a block link in the ordered data structure, then a user is optionally notified that the ordered data structure is missing a block link for a block of equations, block 1608. The system can inform a user of any missing block links. For example, and without limitation, this can include the moderator program 1530 notifying a user that the order graph 1202 is missing a block link for the SRC2 block of equations 1204, as depicted by FIG. 12. A user can be a person who operates a computer.

If no block of equations is missing a block link in the ordered data structure, then whether any blocks of equations declared as independent variables lack any effect on the optimized values is optionally determined, block 1610. The system can verify whether independent variables have any effect on the optimized values. By way of example and without limitation, this can include the moderator program 1530 determining whether the user-declared independent variable SRC2 lacks any effect on the objective function Yield. An independent variable can be a value whose variation does not depend on the variation of another value. An effect can be a change which is a result or consequence of an action or other cause.

Determining whether any blocks of equations declared as independent variables lacks any effect on the optimized values may include identifying a lack of a path from the block of equations declared as an independent variable in the ordered data structure to a block of equations for an objective function in the ordered data structure. For example, the moderator program 1530 determines that there is no path from the block 1204 for the user-declared independent variable SRC2 to the block 1206 for the objective function, Yield, as depicted by FIG. 12. A lack can be the state of being without or not having enough of something. A path can be the course or direction in which a thing is moving.

If any blocks of equations declared as independent variables lack any effect on the optimized values, then the flowchart 1600 continues to block 1612 to warn the user and/or remove the block from blocks requiring optimization. If all blocks of equations declared as independent variables have effects on the optimized values, then the flowchart 1600 proceeds ahead to block 1614 to optimize the subset of blocks which require optimization.

If any blocks of equations declared as independent variables lack any effect on the optimized values, then a user is optionally warned that such a block of equations declared as an independent variable lacks any effect on the optimized values or the block of equations declared as an independent variable is optionally removed from the blocks of equations that require optimizing by the optimizer program, block 1612. The system can remove equations which do not generate the desired results. In embodiments, this can include the moderator program 1530 warning a user that a block of equations declared as an independent variable lacks any effect on the optimized values or removing the block of equations declared as independent variables from the blocks of equations 1522 that require optimizing by the optimizer program.

Having identified the blocks that do or do not require optimization, an optimizer program optimizes only the subset of the blocks of equations that require optimizing by the optimizer program, thereby reducing an amount of computer resources required for optimization, by varying any blocks of equations declared as independent variables in an iterative process until the optimizer program generates optimized values that converge on a solution, block 1614. The system conserves computer resources by solving only a subset of the blocks. Converging on the solution may include yielding an improved result for the simulation model. For example, and without limitation, this can include the optimizer program 1526 conserving computer resources by optimizing only the 11 blocks identified as requiring optimization to generate optimized values, instead of spending computer resources on optimizing all 20 blocks.

An amount can be a quantity of something, especially the total of a thing or things in number, size, value, or extent. A computer resource can be any physical or virtual component of an electronic system that is limited in availability, which can be hardware or software, and can be used to receive, analyze, and store data to solve problems and create solutions. An iterative process can be a series of actions or steps taken in order to achieve a particular method of problem-solving or decision-making that involves repeating a series of the steps until a desired outcome is achieved. An improved result can be an increase in quality to a solution.

After optimized values are created by optimizing a subset of the blocks, a solver program uses the optimized values to execute each calculation only once when sequentially solving the remaining set of the blocks of equations, block 1616. The system conserves computer resources by solving only a subset of the blocks. Sequentially solving the remaining set of the blocks of equations may include verifying that any tolerances are met by the optimization. By way of example and without limitation, this can include the solver program 1528 using the optimized values, which converge on a solution that yields increased profit, and conserving computer resources by solving only the remaining 9 blocks, which are blocks <4, 7, 8, 10, 12-16>. A solver program can be a piece of mathematical software, possibly in the form of a stand-alone computer program or as a software library, which derives a solution to a mathematical problem, sometimes by taking problem descriptions in some sort of generic form and by calculating their solution. A calculation can be a mathematical determination of the size or number of something. A tolerance can be an allowable amount of variation of a specified quantity, especially in the dimensions of a machine or part.

Since the optimizer program traditionally optimizes all blocks of equations of the simulation model through multiple iterations, the moderator program moves as many of the optimization calculations as possible from the optimizer program to the solver program, which should execute each calculation only once, leading to an overall increase in optimizing speed and a reduction in optimizing time of a computer's optimization calculations, while producing the same results. The moderator program reduces the computer resources needed for feasible-path optimization calculations by reducing the simulation model's size during the optimization phase and/or reducing solver runtime by using optimal values determined during optimization. The moderator program also implements simulations that include fewer errors by deferring the calculation of certain “problem” blocks of equations from an optimizer program calculation tor a solver program calculation. Consequently, the moderator program simplifies troubleshooting by avoiding misleading diagnostic information for blocks that are not needed to be optimized by the optimizer program.

Although FIG. 16 depicts the blocks 1602-1616 occurring in a specific order, the blocks 1602-1616 can occur in another order. In other implementations, each of the blocks 1602-1616 can also be executed in combination with other blocks and/or some blocks may be divided into a different set of blocks.

An exemplary hardware device in which the subject matter may be implemented shall be described. Those of ordinary skill in the art will appreciate that the elements illustrated in FIG. 17 can vary depending on the system implementation. With reference to FIG. 17, an exemplary system for implementing the subject matter disclosed herein includes a hardware device 1700, including a processing unit 1702, a memory 1704, a storage 1706, a data entry module 1708, a display adapter 1710, a communication interface 1712, and a bus 1714 that couples elements 1704-1712 to the processing unit 1702.

The bus 1714 can comprise any type of bus architecture. Examples include a memory bus, a peripheral bus, a local bus, etc. The processing unit 1702 is an instruction execution machine, apparatus, or device and can comprise a microprocessor, a digital signal processor, a graphics processing unit, an application specific integrated circuit (ASIC), a field programmable gate array (FPGA), etc. The processing unit 1702 may be configured to execute program instructions stored in the memory 1704 and/or the storage 1706 and/or received via the data entry module 1708.

The memory 1704 can include a read only memory (ROM) 1716 and a random-access memory (RAM) 1718. The memory 1704 may be configured to store program instructions and data during operation of the hardware device 1700. In various embodiments, the memory 1704 can include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 1704 can also include nonvolatile memory technologies such as nonvolatile flash RAM (NVRAM) or ROM. It is contemplated that the memory 1704 can include a combination of technologies such as the foregoing, as well as other technologies not specifically mentioned. When the subject matter is implemented in a computer system, a basic input/output system (BIOS) 1720, containing the basic routines that help to transfer information between elements within the computer system, such as during start-up, is stored in the ROM 1716.

The storage 1706 can include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 1700.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like can also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 1706, the ROM 1716 or the RAM 1718, including an operating system 1722, one or more applications programs 1726, program data 1726, and other program modules 1728. A user can enter commands and information into the hardware device 1700 through data entry module 1708. The data entry module 1708 can include mechanisms such as a keyboard, a touch screen, a pointing device, etc.

Other external input devices (not shown) are connected to the hardware device 1700 via an external data entry interface 1710. By way of example and not limitation, external input devices can include a microphone, joystick, game pad, satellite dish, scanner, or the like. External input devices can include video or audio input devices such as a video camera, a still camera, etc. The data entry module 1708 may be configured to receive input from one or more users of the hardware device 1700 and to deliver such input to the processing unit 1702 and/or the memory 1704 via the bus 1714.

A display 1712 is also connected to the bus 1714 via the display adapter 1710. The display 1712 may be configured to display output of the hardware device 1700 to one or more users. A given device such as a touch screen, for example, can function as both the data entry module 1708 and the display 1712. External display devices can also be connected to the bus 1714 via the external display interface 1734. Other peripheral output devices, not shown, such as speakers and printers, may be connected to the hardware device 1700.

The hardware device 1700 can operate in a networked environment using logical connections to one or more remote nodes (not shown) via the communication interface 1712. The remote node may be another computer, a server, a router, a peer device or other common network node, and typically includes many or all of the elements described above relative to the hardware device 1700. The communication interface 1712 can interface with a wireless network and/or a wired network. Examples of wireless networks include, for example, a BLUETOOTH network, a wireless personal area network, a wireless 802.21 local area network (LAN), and/or wireless telephony network (e.g., a cellular, PCS, or GSM network).

Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. The communication interface 1712 can include logic configured to support direct memory access (DMA) transfers between the memory 1704 and other devices.

In a networked environment, program modules depicted relative to the hardware device 1700, or portions thereof, may be stored in a remote storage device, such as, for example, on a server. It will be appreciated that other hardware and/or software to establish a communications link between the hardware device 1700 and other devices may be used.

It should be understood that the arrangement of the hardware device 1700 illustrated in FIG. 17 is but one potential implementation and that other arrangements are feasible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 1700.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 17.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter can also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tic-up a judicial exception with known conventional steps implemented by a general-purpose computer; nor do they attempt to tic-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included may be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Any text in the drawings are part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms: Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example. As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the system are useful machine operations. The system also relates to a device or an apparatus for performing these operations. All flowcharts presented herein represent computer implemented steps and/or are visual representations of algorithms implemented by the system.

The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general-purpose computer selectively activated or configured by one or more computer programs stored in the computer memory, cache, or obtained over a network. When data is obtained over a network the data may be processed by other computers on the network, e.g., a cloud of computing resources.

The embodiments of the system can also be defined as a machine that transforms data from one state to another state. The data can represent an article, which may be represented as an electronic signal and electronically manipulate data. The transformed data can, in some cases, be visually depicted on a display, representing the physical object that results from the transformation of data. The transformed data may be saved to storage generally, or in particular formats that enable the construction or depiction of a physical and tangible object. The manipulation may be performed by a processor.

In such an example, the processor thus transforms the data from one thing to another. Still further, some embodiments include methods that may be processed by one or more machines or processors that may be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations may be performed in between operations, operations may be adjusted so that they occur at slightly different times, and/or operations may be distributed in a system which allows the occurrence of the processing operations at various intervals associated with the processing, as long as the processing of the overlay operations are performed in the desired way and result in the desired system output. It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

What is claimed is:

1. A system for reducing optimization time of simulation models, the system comprising:
one or more processors; and
a non-transitory computer readable medium storing a plurality of instructions, which when executed, cause the one or more processors to:
identify an ordered data structure that enables a computer to follow a particular order of execution for solving blocks of equations that collectively constitute a simulation model;
identify, based on the ordered data structure, at least one of a subset of the blocks of equations that require optimizing by an optimizer program or a remaining set of blocks of equations which can be solved without optimization by the optimizer program;
optimize, by the optimizer program, only the subset of the blocks of equations that require optimizing by the optimizer program, thereby reducing an amount of computer resources required for optimization, by varying any blocks of equations declared as independent variables in an iterative process until the optimizer program generates optimized values that converge on a solution; and
execute, by a solver program that uses the optimized values, each calculation only once when sequentially solving the remaining set of the blocks of equations.

2. The system of claim 1, wherein the ordered data structure comprises a least one of an order table, an order graph, a directed graph, or a solver dependencies graph, and the blocks of equations are created by an industrial process simulator that divides the simulation model for an industrial process.

3. The system of claim 1, wherein identifying the subset of the blocks of equations that require optimizing by the optimizer program comprises traversing the ordered data structure from a block of equations for an objective function to each of the blocks of equations declared as independent variables, and identifying each block of equations visited during the traversing as requiring optimizing by the optimizer program.

4. The system of claim 1, wherein identifying the subset of the blocks of equations that require optimizing by the optimizer program comprises at least one of identifying a block of equations that have variable bounds, which are executed to prevent convergence on erroneous results, or traversing the ordered data structure from each block of equations that have variable bounds to each of the blocks of equations declared as independent variables, identifying each block of equations visited during the traversing as requiring optimizing by the optimizer program, and sending each variable bound identified during the traversing to the optimizer program so the optimizer program can manipulate a solution for blocks of equations declared as independent variables without violating any variable bound on any other solution for any other blocks of equations declared as independent variables.

5. The system of claim 1, wherein the plurality of instructions further causes the processor to at least one of warn a user that a block of equations declared as an independent variable lacks any effect on the optimized values or remove the block of equations declared as an independent variable from the blocks of equations that require optimizing by the optimizer program, in response to a determination that the block of equations declared as an independent variable lacks any effect on the optimized values.

6. The system of claim 5, wherein determining that the block of equations declared as an independent variable lacks any effect on the optimized values comprises identifying a lack of a path from the block of equations declared as an independent variable in the ordered data structure to a block of equations for an objective function in the ordered data structure, converging on the solution comprises yielding an improved result for the simulation model, and sequentially solving the remaining set of the blocks of equations comprises verifying that any tolerances are met by the optimization.

7. The system of claim 1, wherein the plurality of instructions further causes the processor to notify a user that the ordered data structure is missing a block link for a block of equations, in response to a determination that the block of equations is missing the block link.

8. A computer-implemented method for reducing optimization time of simulation models, the computer-implemented method comprising:
identifying an ordered data structure that enables a computer to follow a particular order of execution for solving blocks of equations that collectively constitute a simulation model;
identifying, based on the ordered data structure, at least one of a subset of the blocks of equations that require optimizing by an optimizer program or a remaining set of blocks of equations which can be solved without optimization by the optimizer program;
optimizing, by the optimizer program, only the subset of the blocks of equations that require optimizing by the optimizer program, thereby reducing an amount of computer resources required for optimization, by varying any blocks of equations declared as independent variables in an iterative process until the optimizer program generates optimized values that converge on a solution; and
executing, by a solver program that uses the optimized values, each calculation only once when sequentially solving the remaining set of the blocks of equations.

9. The computer-implemented method of claim 8, wherein the ordered data structure comprises a least one of an order table, an order graph, a directed graph, or a solver dependencies graph, and the blocks of equations are created by an industrial process simulator that divides the simulation model for an industrial process.

10. The computer-implemented method of claim 8, wherein identifying the subset of the blocks of equations that require optimizing by the optimizer program comprises traversing the ordered data structure from a block of equations for an objective function to each of the blocks of equations declared as independent variables, and identifying each block of equations visited during the traversing as requiring optimizing by the optimizer program.

11. The computer-implemented method of claim 8, wherein identifying the subset of the blocks of equations that require optimizing by the optimizer program comprises at least one of identifying a block of equations that have variable bounds, which are executed to prevent convergence on erroneous results, or traversing the ordered data structure from each block of equations that have variable bounds to each of the blocks of equations declared as independent variables, identifying each block of equations visited during the traversing as requiring optimizing by the optimizer program, and sending each variable bound identified during the traversing to the optimizer program so the optimizer program can manipulate a solution for any blocks of equations declared as independent variables without violating any variable bound on any other solution for any other blocks of equations declared as independent variables.

12. The computer-implemented method of claim 8, wherein the computer-implemented method further comprises at least one of warning a user that a block of equations declared as an independent variable lacks any effect on the optimized values or removing the block of equations declared as an independent variable from the blocks of equations that require optimizing by the optimizer program, in response to a determination that the block of equations declared as an independent variable lacks any effect on the optimized values.

13. The computer-implemented method of claim 12, wherein determining that the block of equations declared as an independent variable lacks any effect on the optimized values comprises identifying a lack of a path from the block of equations declared as an independent variable in the ordered data structure to a block of equations for an objective function in the ordered data structure, converging on the solution comprises yielding an improved result for the simulation model, and sequentially solving the remaining set of the blocks of equations comprises verifying that any tolerances are met by the optimization.

14. The computer-implemented method of claim 8, wherein the computer-implemented method further comprises notifying a user that the ordered data structure is missing a block link for a block of equations, in response to a determination that the block of equations is missing the block link.

15. A computer program product, comprising a non-transitory computer-readable medium having a computer-readable program code embodied therein to be executed by one or more processors, the program code including instructions to:
identify an ordered data structure that enables a computer to follow a particular order of execution for solving blocks of equations that collectively constitute a simulation model;
identify, based on the ordered data structure, at least one of a subset of the blocks of equations that require optimizing by an optimizer program or a remaining set of blocks of equations which can be solved without optimization by the optimizer program;
optimize, by the optimizer program, only the subset of the blocks of equations that require optimizing by the optimizer program, thereby reducing an amount of computer resources required for optimization, by varying any blocks of equations declared as independent variables in an iterative process until the optimizer program generates optimized values that converge on a solution; and
execute, by a solver program that uses the optimized values, each calculation only once when sequentially solving the remaining set of the blocks of equations.

16. The computer program product of claim 15, wherein the ordered data structure comprises a least one of an order table, an order graph, a directed graph, or a solver dependencies graph, and the blocks of equations are created by an industrial process simulator that divides the simulation model for an industrial process.

17. The computer program product of claim 15, wherein identifying the subset of the blocks of equations that require optimizing by the optimizer program comprises at least one of traversing the ordered data structure from a block of equations for an objective function to each of the blocks of equations declared as independent variables, and identifying each block of equations visited during the traversing as requiring optimizing by the optimizer program, identifying a block of equations that have variable bounds, which are executed to prevent convergence on erroneous results, or traversing the ordered data structure from each block of equations that have variable bounds to each of the blocks of equations declared as independent variables, identifying each block of equations visited during the traversing as requiring optimizing by the optimizer program, and sending each variable bound identified during the traversing to the optimizer program so the optimizer program can manipulate a solution for any blocks of equations declared as independent variables without violating any variable bound on any other solution for any other blocks of equations declared as independent variables.

18. The computer program product of claim 15, wherein the program code includes further instructions to at least one of warn a user that a block of equations declared as an independent variable lacks any effect on the optimized values or remove the block of equations declared as an independent variable from the blocks of equations that require optimizing by the optimizer program, in response to a determination that the block of equations declared as an independent variable lacks any effect on the optimized values.

19. The computer program product of claim 18, wherein determining that the block of equations declared as an independent variable lacks any effect on the optimized values comprises identifying a lack of a path from the block of equations declared as an independent variable in the ordered data structure to a block of equations for an objective function in the ordered data structure, converging on the solution comprises yielding an improved result for the simulation model, and sequentially solving the remaining set of the blocks of equations comprises verifying that any tolerances are met by the optimization.

20. The computer program product of claim 15, wherein the program code includes further instructions to notify a user that the ordered data structure is missing a block link for a block of equations, in response to a determination that the block of equations is missing the block link.
